(19) United States
(12) Patent Application Publication
(10) Pub. No.: US 2006/0162575 A1
(43) Pub. Date: Jul. 27, 2006

(54) Accessory for grill and grill

(75) Inventor: Kwok Kay Lee, Hong Kong (HK)

Correspondence Address: LEYDIG VOIT & MAYER, LTD, 700 THIRTEENTH ST. NW, SUITE 300, WASHINGTON, DC, 20005-3960, US

(73) Assignee: Main Power Electrical Factory Ltd., Kwun Tong (HK)

(21) Appl. No.: 11/042,349

(22) Filed: Jan. 26, 2005

(51) Int. Cl. A47J 37/07

(52) U.S. Cl. 99/450

(57) ABSTRACT

An accessory for a grill has a flat thin metal plate with a flange for movably connecting the plate to a grill. The grill has a heated cooking platen on a base. The plate is movable between a first position extending parallel to and opposite the platen and a second position perpendicular to the platen.

### BACKGROUND TO THE INVENTION

1. Field of the Invention

The invention relates to accessories for grills and grills.

2. Description of Prior Art

A grill for the preparation of food items comprises a base supporting a flat heated cooking platen. This type of device is also known as a griddle.

Food items are placed on the platen for cooking. Some types of food cook better if pressed or flattened against the platen. This is typically done using a flat cooking utensil, however this is tiresome for the chef and prevents the chef from attending to preparation of other food items while waiting for the current food item to cook.

Other problems with known grills, or griddles, is the provision of warming and draining space for cooked food items, and storage of utensils.

### SUMMARY OF THE INVENTION

It is an object of the present invention to provide an accessory for a grill and a grill that overcome the above problems or which at least provide the public with a useful alternative.

According to a first aspect of the invention there is provided an accessory for a grill comprising a flat thin metal plate having an edge, and a flange connecting to the plate at the edge for movable attachment of the plate to a grill.

Preferably, the accessory includes an arm connecting the flange and plate.

Preferably, the plate has a plurality of perforations.

Preferably, the flange is pivotally and/or slidably attached to the grill.

Preferably, the accessory includes handle integrally formed with the plate.

Preferably, the accessory includes a support pivotally attached to the plate opposite the flange.

Preferably, the accessory includes a plurality of ribs for supporting a food item on the plate

According to a second aspect of the invention there is provided a grill comprising:
a base,
a heated cooking platen provided on the base,
a flat thin metal plate pivotally attached to the base and moveable between a first position extending parallel over the platen and a second position perpendicular to the platen.

Further aspects of the invention will become apparent from the following drawings and description.

### BRIEF DESCRIPTION OF THE DRAWINGS

Embodiments of the invention will now be described by way of example only and with reference to the accompanying in which:

FIGS. 1 to 6 are various views of a grill and accessory according to the invention, and

FIG. 7 and 8 are close up views of a flange attaching the accessory to the grill.

### DESCRIPTION OF THE PREFERRED EMBODIMENTS

In the drawings there is depicted a grill comprising a base 1 with a heated cooking platen 2 provided on the base 1. The arrangement and operation of the base 1 and heated cooking platen 2 are typical of grills already known in the art. The platen may be heated by gas, coals, electricity or other known means. In the preferred embodiment the grill is electric.

In accordance with the preferred embodiment of the invention an edge 3 of the base has a beaded lip 4 extending along it length. A perforated flat thin metal plate 5 has dimensions so that it fits parallel over the platen 2 through its entire width and a portion of its length. Extending from an edge 6 of the plate 5 is an arm and flange 7. The flange 7 engages beaded lip 4 providing a hinged joint to pivotally attach the plate 5 to the base 1. The opposite edge 8 of plate 5 has an integrally formed handle 9.

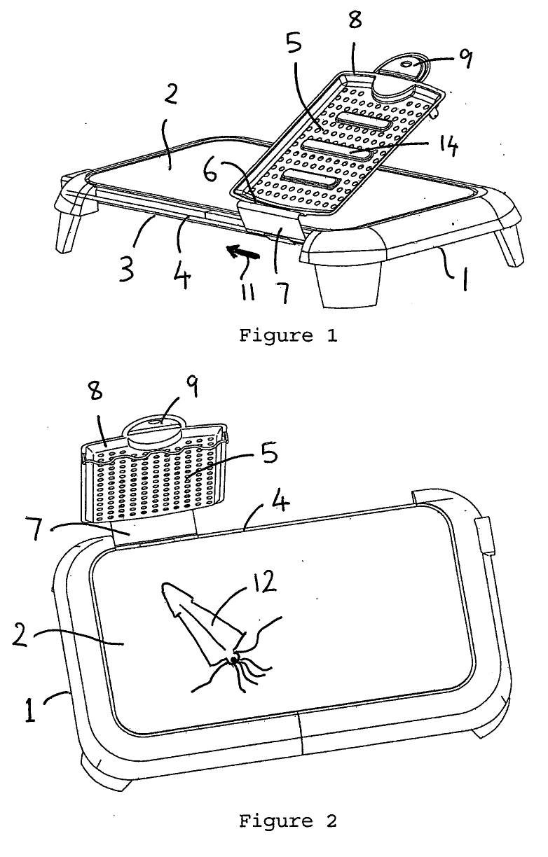

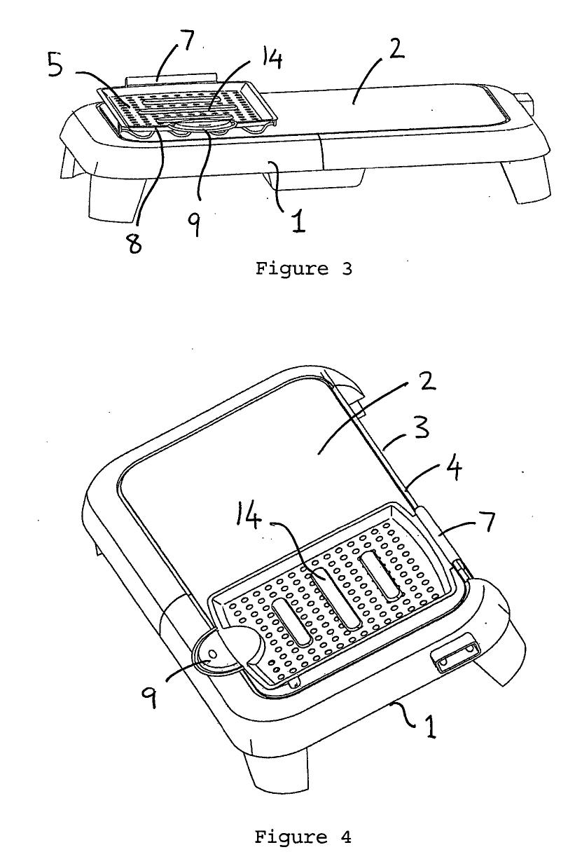

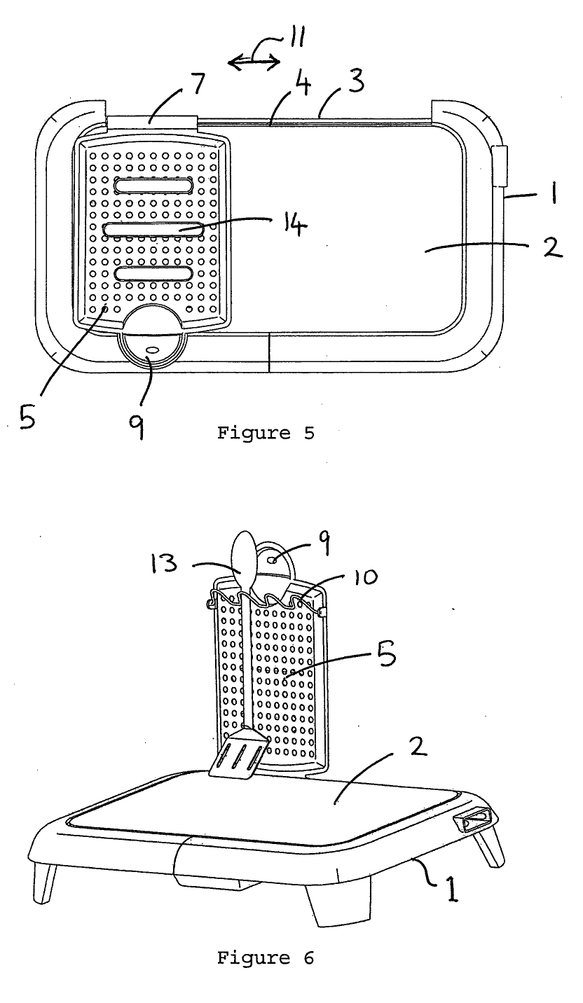

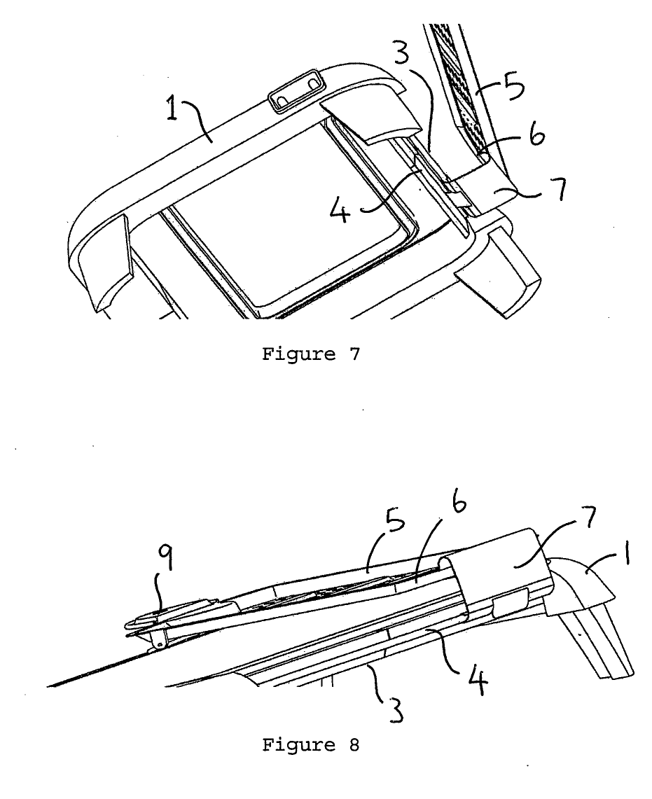

The plate 5 is pivotal between a first position, FIGS. 3, 4 and 5, extending parallel over the platen 5 and a second position, FIGS. 1, 2 and 6, perpendicular to the platen 5. The flange 7 also slides along beaded lip 4, as indicted by arrow 11, allowing the plate 5 to be positioned at different positions along the length of the platen 5.

The plate 5 is made of stainless steel. Alternatively, the plate is metal covered with a non-stick coating.

A support bar 10 is pivotally attached to the plate 5 proximate edge 8 opposite flange 7. The support bar 10 is made from a wire strand bent at each end to connect to the plate 5. Between the bent ends the support bar 10 is bent in a scallop arrangement.

The perforated metal plate 5 is a useful accessory for the grill. It can be lowered to press or flatten food items, such as cuttlefish 12, on the grill platen 2. It can be raised to its perpendicular position, FIG. 6, and the support bar 10 extended to provide a rack for utensils such as spatula 13.

With the support bar 10 extended plate 5 can be lowered over the platen 2, with end 8 supported by support bar 10 to provide a warming or draining rack for cooked foods. For this purpose, the top side of plate 5 is provided with a plurality of ribs 14 for supporting the cooked foods.

Where in the foregoing description reference has been made to integers or elements having known equivalents then such are included as if individually set forth herein.

Embodiments of the invention have been described, however it is understood that variations, improvement or modifications can take place without departure from scope of the appended claims.

1. An accessory for a grill comprising:
a flat thin metal plate having an edge, and
a flange connecting to the plate at the edge for movable attachment of the plate to a grill.

2. The accessory of claim 1 further including an arm connecting the flange and plate.

3. The accessory of claim 1 wherein the plate has a plurality of perforations.

4. The accessory of claim 1 wherein the flange is pivotally attachable to the grill.

5. The accessory of claim 1 wherein the flange is slidably attachable to the grill.

6. The accessory of claim 1 wherein the flange is pivotally and slidably attachable to the grill.

7. The accessory of claim 1 further including a handle integral with the plate.

8. The accessory of claim 1 further including a support pivotally attached to the plate opposite the flange.

9. The accessory of claim 1 wherein the plate includes a plurality of ribs for supporting a food item on the plate.

10. A grill comprising:
a base,
a heated cooking platen on the base,
a flat thin metal plate pivotally attached to the base and moveable between a first position extending parallel to and opposite the platen and a second position perpendicular to the platen.

11. The grill of claim 10 wherein the flat thin metal plate is perforated.

12. The grill of claim 10 further including a handle integral with the plate.

13. The grill of claim 10 further including a support pivotally connected to the plate.

14. The attachment of claim 10 wherein the plate includes a plurality of ribs for supporting a food item on the plate.
